(19) United States
(12) Patent Application Publication
(10) Pub. No.: US 2009/0328193 A1
(43) Pub. Date: Dec. 31, 2009

(54) System and Method for Implementing a Virtualized Security Platform

(76) Inventors: Hezi Moore, Atlanta, GA (US); John Uliss Peterson, Alpharetta, GA (US)

Correspondence Address: J. Michael Martinez de Andino. Esq.;HUNTON & WILLIAMS LLP, Riverfront Plaza, East Tower, 951 E. Byrd Street, Richmond, VA, 23219-4074, US

(21) Appl. No.: 11/780,687

(22) Filed: Jul. 20, 2007

(51) Int. Cl. H04L 9/32

(52) U.S. Cl. 726/15

(57) ABSTRACT

A virtual security platform residing in a virtualization layer on a host data processing machine is provided. The virtual security platform comprises at least one virtual security appliance, each of which is configured for receiving, via a network interface, data communications from at least one data communication source. Each virtual security appliance is also configured for initiating a security function responsive to one of said data communications meeting predetermined criteria.

This application claims priority to U.S. application Ser. No. 11/680,858 filed Mar. 1, 2007, which claims priority to U.S. Provisional App No. 60/779,127, both of which are incorporated herein by reference in their entirety.

### BACKGROUND OF THE INVENTION

The present invention relates to computer networking and network security. More particularly, the invention relates to virtualized network security systems. The use of network security technology can help organizations prevent damage to computer resources, safeguard sensitive data, maintain regulatory compliance, avoid business disruptions and more. However, it can also increase management, operational and budgetary challenges.

As network security needs increase within an organization, additional physical computers are frequently installed to handle incremental security applications and processing workloads. However, this can result in a proliferation of physical computers that creates operational, logistical and total cost of ownership (TCO) issues. This computing model may also waste capital resources, because security applications typically don't fully utilize CPU, memory and other capacities on a given machine. This means organizations may purchase and maintain computing resources that are frequently under-utilized or idled. In addition, organizations may be unable to fully leverage advanced performance computer capabilities such as multi-core processors, large disk storage and memory arrays, etc.

One solution to these computing problems is security server virtualization. Server virtualization uses specially-designed software to create “virtual machines” that run simultaneously on, and share the resources of, a single physical machine (a host).

By allowing virtual machines to share host computer resources, virtualized security configurations can make more efficient use of existing computing capacity and consolidate the number of physical computers that must be purchased, installed and maintained to deliver a targeted level of network security performance.

Virtualized security solutions can help organizations avoid many management, logistical and operational issues associated with dedicating multiple physical computers to security applications.

As compared to security solutions that require dedicated physical computers, virtualized security solutions can also help organizations achieve more flexibility, efficiency and scalability.

Virtualized security solutions can also help organizations better leverage advanced processing capabilities available on a given physical host computer. Virtualized security solutions also have the capability to effectively partition and allocate these resources so that appropriate computing resources are made available to individual virtualized security applications operating on the host platform.

### SUMMARY OF THE INVENTION

In one illustrative aspect, the invention provides a virtual security platform residing in a virtualization layer on a host data processing machine. The virtual security platform comprises at least one virtual security appliance (VSA), each of which is configured for receiving, via a network interface, data communications from a least one data communication source. Each virtual security appliance is also configured for initiating a security function responsive to one of said data communications meeting predetermined criteria.

In another illustrative aspect, the invention provides a method of securing data communications from a plurality of data communications sources using a virtual security platform running on a host data processing machine. The virtual security platform comprises at least one virtual security appliance. The method comprises routing each data communication to the at least one virtual security appliance of the virtual security platform, and, responsive to a determination that the routed data communication meets the predetermined criteria, initiating a security function.

Further objects, features and advantages of the invention will be apparent from the description below taken in conjunction with the accompanying drawings.

### BRIEF DESCRIPTION OF THE DRAWINGS

FIG. 1 is a schematic representation of a virtual security appliance that may be used in systems and methods of the invention.

FIG. 2 is a schematic representation of a virtual security platform according to an embodiment of the invention.

FIG. 3 is a schematic representation of a virtual security platform in an internally load balanced configuration according to an embodiment of the invention.

FIG. 4 is a schematic representation of a virtual security platform in an externally load-balanced configuration according to an embodiment of the invention.

FIG. 5 is a schematic representation of a virtual security platform with load balancing across multiple network segments according to an embodiment of the invention.

FIG. 6 is a schematic representation of a virtual security platform in a load-balanced configuration according to an embodiment of the invention.

FIG. 7 is a schematic representation of a virtual security platform in a load-balanced and content-switched configuration according to an embodiment of the invention.

### DETAILED DESCRIPTION OF THE INVENTION

Server virtualization uses software to create multiple virtual devices that run simultaneously on and share the resources of a single physical machine (host machine) and virtual networks that create a virtualized local area communications network infrastructure within the host machine. Thus, a single physical machine may contain several virtual machines communicating with one another over one or more virtual networks.

The virtual security systems of the present invention may be used to provide a virtualized security platform that can be installed on a host machine and used to protect physical and virtualized computing resources that are external to the host machine.

The virtual security systems of the invention can also be used to holistically protect the virtualization layer and the host machine itself from threats contained within data communications from virtualized computing elements on the host platform and computing resources external to the host.

The present invention makes use of virtual security appliances to provide security infrastructures for protecting virtual and physical machines and devices interconnected by data communication networks. As used herein, the term “virtual environment” refers to a simulated computing environment running on a physical host machine that replicates the functionality and interfaces of a physical computing environment. A “virtual device” is a simulated representation of the functionality and interfaces provided by a physical network component. As used herein, the terms “host” and “host machine” refer to the data processing equipment that provides the physical environment and computing resources used to support one or more virtual machines. The term “virtual network” refers to a virtualized infrastructure running on a host machine. This infrastructure forms a virtualized networked communication environment that may include a variety of virtual devices including but not limited to virtual switches, routers, segments, network interface cards and other virtual elements. Virtual machines and networks are typically established on a host machine through the use of specialized software packages that define the rules and operating characteristics of the virtual environment. In some instances, it may also be possible to define a virtual environment via hardware.

In most relevant respects, operation of a virtual network and communications between virtual network devices and other virtual or physical network devices are executed in the same manner as operation of and communications on a physical network. The present invention provides the desired threat protection through the use of virtual security appliances (VSAs). VSAs are virtual devices defined under the constraints of the virtual network operating system residing on the host machine.

It will be understood that from the perspective of the security/sensor platform software, VSAs may be substantially similar to physical devices. They differ in that physical security devices make use of discrete, dedicated physical components (CPU, memory, storage media, network interface cards, etc.) while VSAs make use of host machine resources to replicate the functions of such physical components. Once the virtual components are established, however, it is generally possible to implement security software programs that are identical or slightly modified versions of the security software programs used in physical security devices.

The VSAs of the invention may be used to provide a virtual security platform for protecting physical and virtual networks residing on a machine other than the host machine of the VSAs. Traditionally, network security solutions have been deployed on a physical machine, either as software and/or a solid-state device. This approach creates two significant problems:
1. Inefficient resource use: Conventional network security solutions are restricted to rigid and inefficient allocations of physical computing resources such as CPUs, memory, etc. This wastes resources and limits the amount of computing power available to security applications. It may also limit the ability of security applications to fully utilize processing capabilities available on the host machine.
2. Ineffective resource partitioning: Conventional network security solutions operating in a shared hardware configuration lack the ability to effectively partition and guarantee access to computing resources. This lack of isolation means an issue (device failure, demand overload, improper configuration, etc) in one security component may affect or degrade the performance of other security components on the same platform.

The virtual security systems of the invention address this problem by allowing information security software to be deployed on a discrete physical resource in a range of N:N configurations. This allows security solutions to be deployed in parallel or in series without requiring incremental computing hardware, network reconfiguration, floor space or other resources.

The virtualized security platforms of the invention have a number of unique capabilities as described in the following paragraphs.

First, a virtualized platform allows multiple security software solutions to effectively use, share and allocate available hardware resources installed in the Host machine. The virtualization hypervisor provides the ability to assign CPUs, CPU cores, storage, memory and other Host hardware resources in whole or part to distinct software-based virtual machines, virtual IPS instances, etc.

Virtualization provides the ability to guarantee, partition and police the use of host hardware resources by distinct virtualized elements. For example, a software-based virtual IPS instance can receive a guaranteed level of resource allocation and/or operate under a resource quota. This approach efficiently allocates hardware among various virtual elements and ensures an overtaxed, malfunctioning and/or ill-behaved software application does't impede the operation of other devices in the virtualized environment.

Virtualized security resources can be shared among external physical devices via the use of virtualized and/or physical load balancing devices. In this manner, virtualized security resources may be shared among various VLANs, IPs, networks, MAC addresses or other network assets based on transient or persistent demand availability congestion conditions traffic protocol, application traffic content or other criteria.

By allocating computing resources logically rather than physically, virtualization offers more flexible and powerful intrusion prevention/security capabilities. It also reduces security server proliferation, eases management issues and eliminates the need for physical hardware provisioning/network reconfiguration resulting from increased network demand, device failures, etc.

For example, a virtualized security platform running ten VSAs could allocate three VSAs to a single high-traffic virtual network, five VSAs to a range of low traffic subnets and two VSAs as failover/hot-standby units. If a need to provide IPS capabilities to a new network resource arises, the virtualization and load balancing rules could be logically reconfigured.

The VSAs of the invention may be configured to use deep packet inspection, content analysis, event aggregation, and other methods to provide any of various network security functions. These security functions may include firewalls, intrusion detection, intrusion prevention, anti-virus applications, anti-spyware applications, denial of service mitigation, network access control, network discovery, network quarantine, identity management, network policy enforcement, and security information reporting. Rules for each of these security functions may be programmed into the VSAs. Such rules define the attributes, thresholds, behaviors and or other characteristics associated with unauthorized or undesirable network traffic.

The VSAs of the invention may be configured so that the processing tasks associated with the above-described security functions are carried out through the use of the host machine's CPU resources. However, VSA security applications (firewall, IDS, IPS, et) can potentially consume significant CPU resources. If the host's core CPU resources are limited, the VSAs of the invention may be configured to offload inspection and analysis tasks to a special, dedicated processor or hardware acceleration card. In a particular embodiment, the VSAs may redirect such tasks to an ASIC-based processor card installed within the host machine chassis. This avoids consuming the limited resources of the host's core CPU resources which in turn avoids degradation of the performance other virtual devices and applications on the host. By allowing a specialized, secondary processor to handle security processing, the VSA is able to deliver security applications without unreasonably affecting or degrading the performance of other elements in the virtualized environment.

VSAs according to some embodiments of the invention may include a mechanism that connects to an administrative interface (also referred to as a “management console”) for purposes of security application management, reporting, system configuration update distribution and other tasks. The management console has the capability to provide aggregated, correlated and interpreted information related to security events that occurred within the virtualized or related environments. The management console may be configured with the capability to create and distribute real-time and historical security event reports in text, graphical and interactive formats; monitor, control and administer a variety of network security services deployed on the VSA (such as Firewall, IPS, Anti Virus etc.); monitor, control and administer select third-party network devices in the virtualized or related network environments; and/or support centralized policy definition and deploy instructions (such as policy changes or updated threat profiles) to one or more VSAs or third-party network devices. The management console and related functions may be deployed on a virtual server or an external physical sensor.

The methods and software devices of the invention may be tailored for deployment in a particular visualization platform. This is significant because the various vendors' virtualization platforms use different rules, processes, terminology, and device definition. Example virtualization platforms include VMware ESX Server, Microsoft Virtual Server 2005 R2], XenSource, and Virtual Iron Software Virtual Iron.

In this application, VSAs were configured so that they (1) replicate the operational attributes and interfaces of a physical network security sensor, and (2) support the desired hardened Linux OS and security software applications.

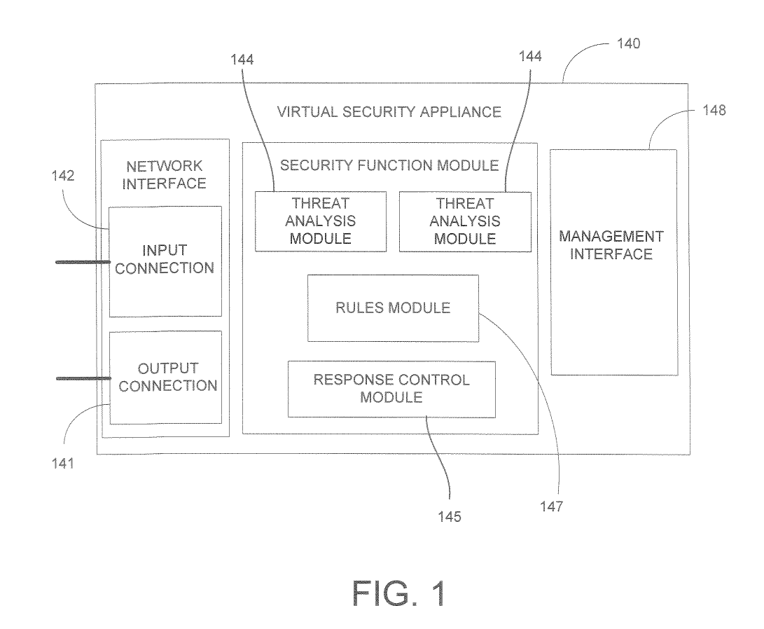

FIG. 1 is a schematic representation of a virtual security appliance 140 according to an embodiment of the invention. Traffic enters the VSA by way of input connection 142. The traffic is inspected by threat analysis modules 144. Traffic attributes are compared to criteria in the rules model 147. The response control model 145 invokes security functions and allows, blocks or interacts with data communications traffic according to predetermined criteria. Traffic exits the device via output connection 141. The device is configured via management interface 148.

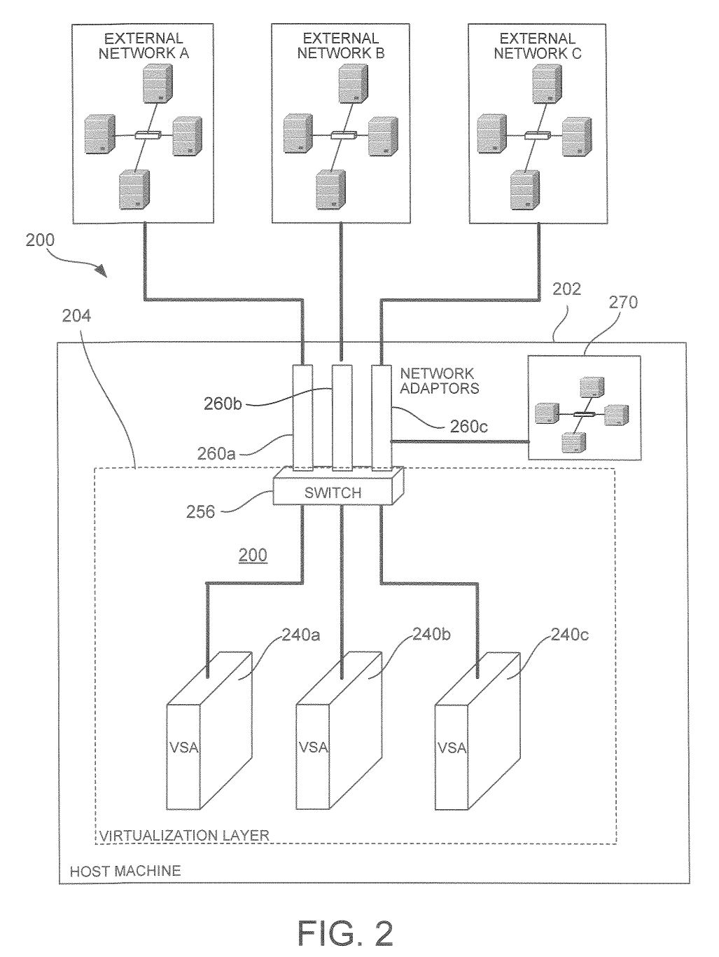

FIGS. 2-7 illustrate exemplary configurations for virtual security platforms according to embodiments of the invention. Each of these configurations depicts an array of VSAs deployed on a single physical computer and delivering security services to various external networks. The virtual security platforms of the invention may use any of these configurations. It will be understood by those of ordinary skill in the art that “1:1” configuration would protect one computing resource (such as a computer, virtual LAN, subnet, IP address) using one VSA. A “1:N” configuration would protect one computing resource (such as a computer, virtual LAN, subnet, IP address) using more than one VSA. An “N:1” configuration would protect more than one computing resource (such as a computer, virtual LAN, subnet, IP address) using one VSA and an “N:N” configuration would protect more than one computing resource (such as a computer, virtual LAN, subnet, IP address) using more than one VSA.

FIG. 2 illustrates a virtualized security system 200 installed in a virtualization layer 204 on a host machine 202. The security system 200 is configured to protect specific devices or networks such as networks A, B and C that are external to the host machine 202. The virtualized security system 200 is also configured to protect host machine resources 270. The external networks A, B and C may be physical networks or they may be virtual networks hosted on one or more physical machines other than the host machine 202. In this configuration the external networks A, B and C are logically matched with corresponding VSAs 240a, 240b, 240c in a 1:1 arrangement. Traffic from, for example, external network A is received at a network adaptor 260a and routed through a virtual switch 256 to an assigned VSA 240a. Traffic from external network B is received at network adaptor 260b and routed to VSA 240b; traffic from external network C is received at network adaptor 260c and routed to VSA 240c. The respective VSAs invoke security functions and allow, block or interact with data communications traffic according to predetermined criteria.

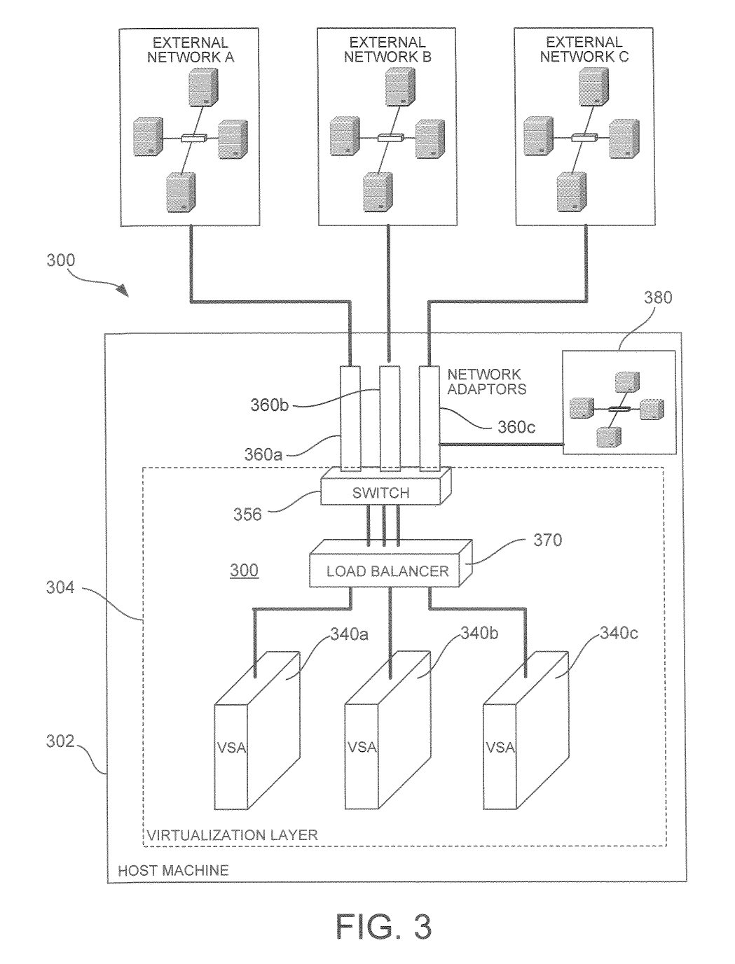

FIG. 3 illustrates another embodiment of a virtualized security system according to the invention. As shown in FIG. 2, the security system 300 is installed in a virtualization layer 304 on a host machine 302 and is configured to protect external networks A, B and C. Traffic is received from these external networks through one of an array of network adaptors 360a, 360b, 360c and a virtual switch 356. A load balancer 370 directs traffic from the external networks A, B, C to an array of VSAs 340a, 340b, 340c, The load balancer 370 assigns traffic to a particular one of the VSAs 340a, 340b, 340c based on demand, resource availability and/or traffic attributes. For example, if the first VSA 340a is busy or out of service, traffic from external network A can be redirected to the second VSA 340b or the third VSA 340c. As a result, the system 300 can deliver greater performance or redundancy for handling traffic from a given external network. The virtualized security system 300 is also configured to protect host machine resources 370.

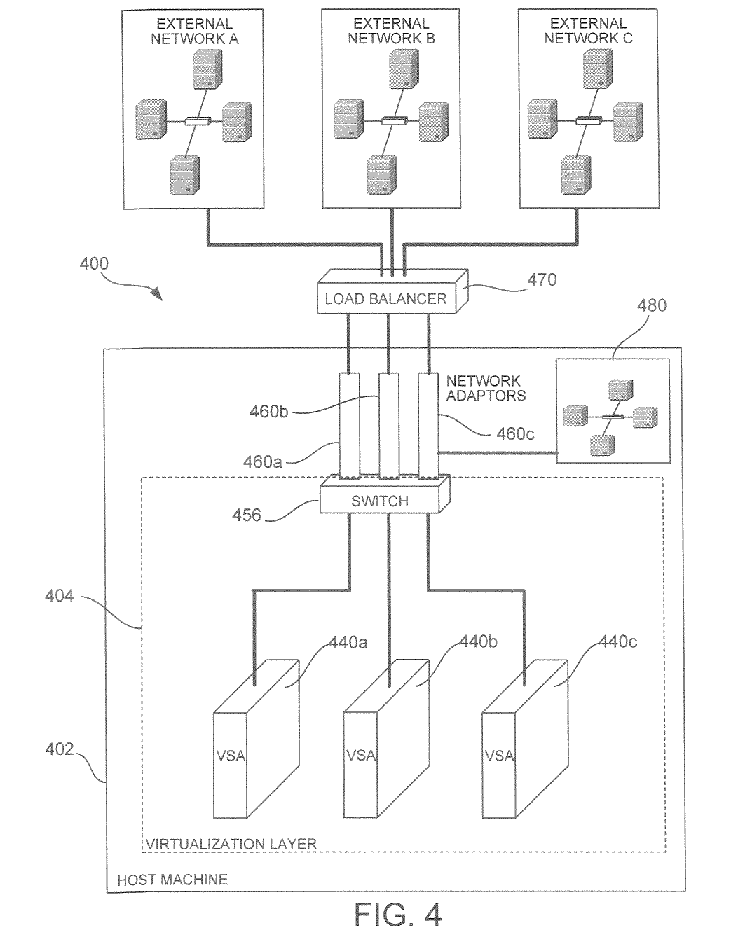

The load function described above may also be accomplished external to the security platform. FIG. 4 illustrates a virtualized security system 400 that is similar to the system 300 of FIG. 3 except that the load balancing function is external to the virtual system 400. The virtual security system 400 is installed in a virtualization layer 404 on a host machine 402 and, as before, is configured to protect external networks A, B and C. As shown in FIG. 4, a load balancer 470 is positioned external to the host machine 402. The load balancer 470 directs traffic from the external networks A, B, C to the network adaptors 460a, 460b, 460c of the security system 400 where it is routed through the virtual switch 456 to VSAs 440a, 440b, 440c based on demand, resource availability and/or traffic attributes. The virtualized security system 400 is also configured to protect host machine resources 470.

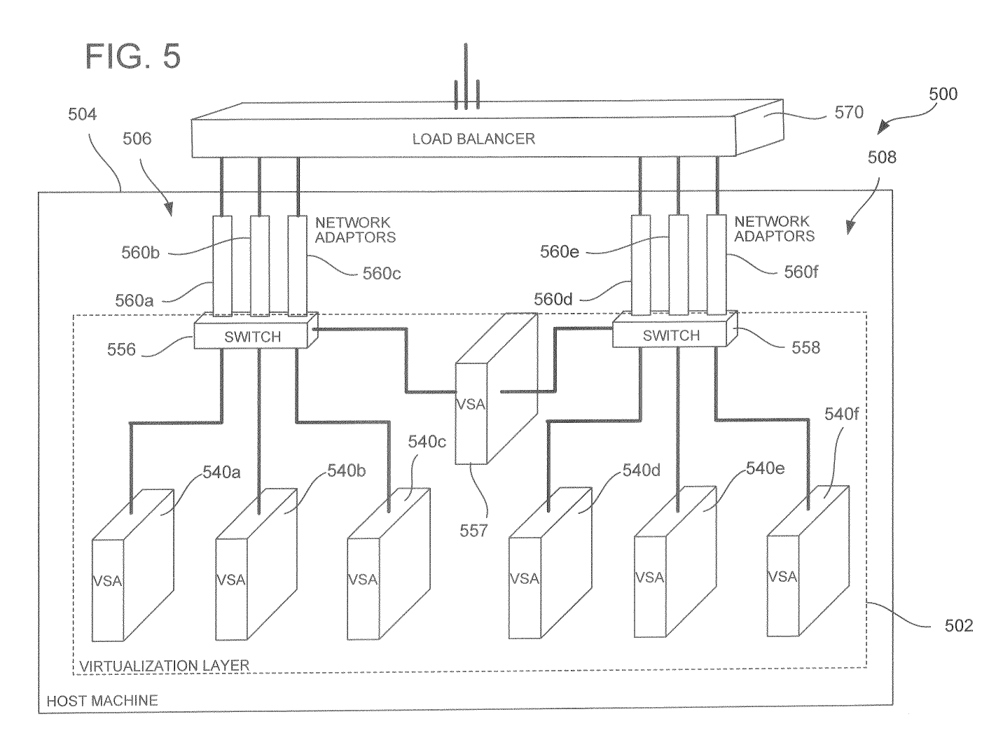

Another exemplary embodiment is schematically illustrated in FIG. 5. In this embodiment, a virtualized security system 500 that includes two virtual security networks 506, 508. Each of the networks 506, 508 is similar to the system 400 of FIG. 4. The virtual security system 500 is installed in a virtualization layer 502 or a host machine 504. In this instance, a load balancer 570 positioned external to the host machine 504 directs traffic to the network adaptors 560a, 560b, 560c of the first network 506 where it is routed through the virtual switch 556 to VSAs 540a, 540b, 540c. The load balancer 570 may also direct traffic to the network adaptors 560d, 560e, 560f of the second network 508 where it is routed through the virtual switch 558 to VSAs 540d, 540e, 540f. The load balancer 570 may be directed to pass traffic from particular origins to specific VSAs or to one or the other of the networks 506, 508. They may also distribute traffic based on demand, resource availability and/or traffic attributes. The first and second networks 506, 508 may be linked via a separate VSA 557, which could be configured for controlling and or monitoring traffic between the networks 506, 508.

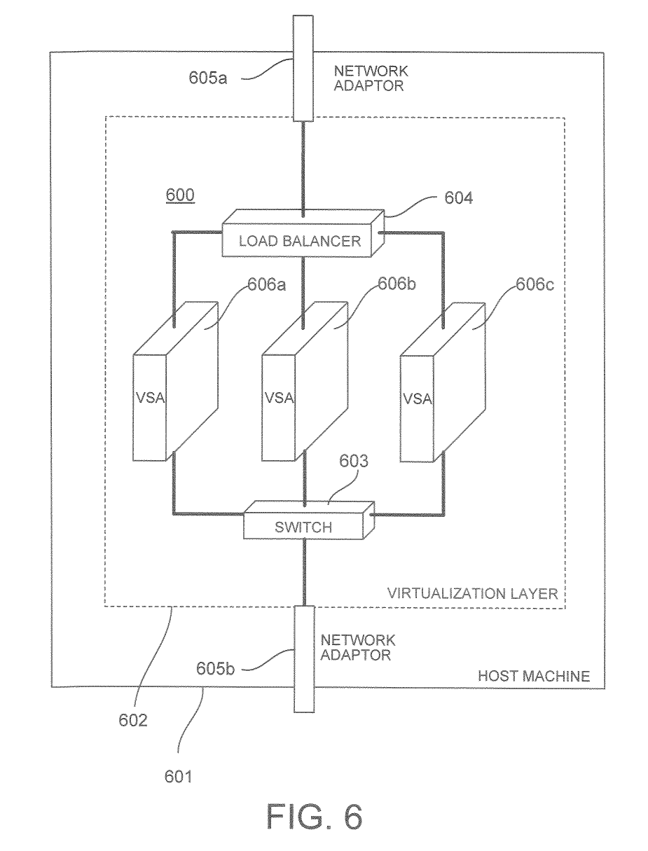

Another exemplary embodiment is schematically illustrated in FIG. 6. This configuration allocates the traffic load across multiple VSA instances based on demand and availability so that overall system performance and throughput is increased. In this embodiment, a virtualized security system 600 is installed in a virtualization layer 602 on the host machine 601. In this instance, traffic from one or more external networks enters the device via network adapter 605a. Traffic is directed to load balancer 604, which allocates traffic to VSA instances 606a, 606b, 606c based on demand, resource availability and/or traffic attributes. Traffic leaving the VSA instances 606a, 606b, 606c exits the system and returns to the external network(s) via virtual switch 603 and network adapter 605b.

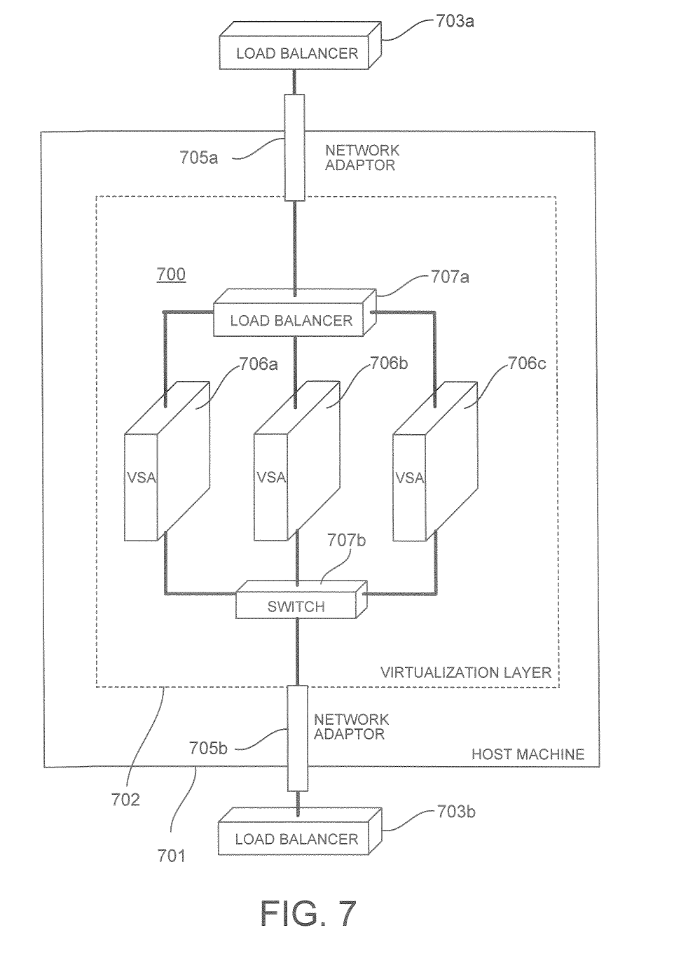

Another exemplary embodiment is schematically illustrated in FIG. 7. This configuration allocates the traffic load across multiple VSA instances based on traffic criteria, so that overall system performance and throughput is increased. In this embodiment, a virtualized security system 700 is installed in a virtualization layer 702 on the host machine 701. In this instance, traffic from one or more external networks enters the device via external load balancer 703a. The external load balancer 703a could be used to allocate traffic to parallel instances of security system 700 operating on other host machines. Traffic proceeds through network adapter 705a and is directed to load balancer 707a, which allocates traffic to VSA instances 706a, 706b, 706c based on demand, resource availability and/or traffic attributes. Traffic leaving the VSA instance 706a, 706b, 706c exits the system and returns to the external network(s) via virtual switch 707b, network adapter 705b and external load balancer 703b.

It will be understood that the virtualized security systems of the invention, including the exemplary systems 200, 300, 400, 500, 600, 700 described above are not limited to a particular number of VSAs and may be used to protect any number of external networks or devices. It will also be understood that the VSAs used may be configured with any desired security function.

In an exemplary system, an Intel architecture system chassis was equipped with 10 Intel single board blade computers. Each blade computer supported a software-based virtualized environment and ten VSA instances (100 VSA instances total). Each blade computer featured dual Intel multi-core processors, 2 GB RAM, and a redundant hard drive array. Additionally the Intel chassis was equipped with a modular switching platform blade that provided interface capabilities between the external local area network and the internal Intel blade computers.

Data communication traffic transited from the local area network to the modular switching platform via 1 Gbps network interface cards and proceeded over the internal hardware backplane to a designated Intel blade computer. Once inside the blade computer, traffic entered the virtualized environment and was directed via virtual switch to a designated VSA instance. The VSA then applied appropriate content inspection and security measures and returned appropriate, legitimate traffic to the local area network via the modular switching platform and 1 Gbps network interfaces.

Operating in this manner, the system was able to provide intrusion protection for multiple external physical resources that in the exemplary environment generated traffic volumes of approximately 3 Gbps.

This exemplary configuration is for reference purposes only and does not define or imply maximum capabilities or performance levels for the invention.

### General Implementation

General aspects of possible implementation of the inventive technology will now be described. Various method and operating system embodiments of the inventive technology are described above. It will be appreciated that the systems of the invention or portions of the systems of the invention may be implemented on a “processing machine” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and or any other input, for example.

As previously discussed, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It will be understood that in order to practice the methods of the invention as described above, is not necessary that the processors and/or the memories of the processing machine be physically located in the same geographical place. That is, each of the processors and the memories used in the invention may be located in geographically distinct locations and connected so as to communicate in any suitable manner. Additionally, it will be understood that each of the processor and/or the memory may be composed of different physical pieces of equipment. Accordingly, it is not necessary that a processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. It will be understood, however, that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, a telecommunications network (e.g., a cellular or wireless network) or any client server system that provides communication, for example. Such communications technologies may use any suitable protocol such as TCP/IP, UDP, or OSI, for example.

As described above a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

It will be understood that the instructions or set of instructions used in the implementation and operation of the invention may be in a suitable form such that the processing machine may read the instructions. For example, the instructions that form a program may be in the form of a suitable program in language which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language Ada, APL, Basic, C++, A#, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine including a computer or computer system for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a magnetic stripe, a laser card, a smart card, a processor chip, a memory chip, a DVD, an integrated circuit, a hard disk, a floppy disk, an optical disk, a flash memory card, a magnetic tape, a RAM, a ROM, a PROM, a EPROM, a wire, a cable, a fiber, communications channel, a satellite transmissions or other remote transmission as well as any other medium or source of data that may by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, telephone (landline, cellular or wireless), voice reader, voice recognizer dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

While the foregoing illustrates and describes exemplary embodiments of this invention, is to be understood that the invention is not limited to the construction disclosed herein. The invention can be embodied in other specific forms without departing from the spirit or essential attributes.

What is claimed is:

1. A virtual security platform residing in a virtualization layer on a host data processing machine, the virtual security platform comprising:
at least one virtual security appliance, each of the at least one virtual security appliance being configured for receiving, via a network interface, data communications from at least one data communication source and for initiating a security function responsive to one of said data communications meeting predetermined criteria.

2. A virtual security platform according to claim 1 wherein the security function comprises an action selected from the set consisting of preventing the data communication from reaching the at least one other virtual network device, activating a security application, creating an electronic record of the data communication and transmitting an alert.

3. A virtual security platform according to claim 1 wherein the predetermine and d criteria includes a set of security rules for use in conjunction with the security function, at least a portion of the security rules being stored in a data storage module in the virtual security appliance.

4. A virtual security platform according to claim 1 wherein the at least one data communication source comprises a virtual network device.

5. A virtual security platform according to claim 1 wherein the at least one data communication source comprises a physical data communication source.

6. A virtual security platform according to claim 1 wherein the virtual security platform is configured so that all of the data communications from a selected one of the at least one data communication source are received by a particular one of the at least one virtual security appliance.

7. A virtual security platform according to claim 1 further comprising:
a virtual load balancer disposed intermediate the network interface and the at least one security sensor, the virtual load balancer being configured for receiving the data communications and, for each data communication, selecting one of the at least one virtual security appliance and directing the data communication to the selected virtual security appliance.

8. A virtual security platform according to claim 7 wherein the virtual load balancer is configured to select the virtual security appliance based on predetermined criteria relating to at least one of the set consisting of communications traffic level and virtual security appliance capacity.

9. A virtual security platform according to claim 1 further comprising:
a virtual switch disposed intermediate the network interface and the at least one security sensor, the virtual switch being configured for receiving the data communications and, for each data communication, selecting one of the at least one virtual security appliance and directing the data communication to the selected virtual security appliance.

10. A virtual security platform according to claim 9 wherein the virtual switch is configured to select the virtual security appliance based on predetermined criteria relating to at least one of the set consisting of communication type and traffic content.

11. A virtual security platform according to claim 1 wherein one or more of the at least one data communication source is external to the host data processing machine.

12. A virtual security platform according to claim 11 wherein the network interface is configured for receiving external data or communications from the one or more of the at least one data communication source external to the host data processing machine via a load balancer external to the virtual security platform and for communicating the external data communications to specific ones of the at least one virtual security appliance as determined by the load balancer.

13. A virtual security platform according to claim 11 wherein the network interface is configured for receiving external data communications from the one or more of the at least one data communication source external to the host data processing machine via a switch external to the virtual security platform and for communicating the external data communications to specific ones of the at least one virtual security appliance as determined by the switch.

14. A method of securing data communications from a plurality of data communications sources using a virtual security platform running on a host data processing machine, the virtual security platform comprising at least one virtual security appliance, the method comprising:
routing each data communication to the at least one virtual security appliance of the virtual security platform; and
responsive to a determination that the routed data communication meets the predetermined criteria, initiating a security function.

15. A method according to claim 14 wherein the security function comprises an action selected from the set consisting of preventing the data communication from reaching the at least one other virtual network device, activating a security application, creating an electronic record of the data communication and transmitting an alert.

16. A method according to claim 14 further comprising:
determining a set of security rules for use in conjunction with the security function; and storing at least a portion of the security rules in a data storage module of the virtual security appliance.

17. A method according to claim 14 wherein the action of routing each data communication includes, for each data communication, selecting one of the at least one virtual security appliance and directing the data communication to the selected virtual security appliance.

18. A method according to claim 17 further comprising:
assigning a particular one of the at least one virtual security appliance to each data communication source so that data communications from a particular data communication source are received only by the assigned virtual security appliance.

19. A method according to claim 17 wherein the virtual security appliance is selected based on predetermined criteria relating to at least one of the set consisting of communications traffic level and virtual security appliance capacity.

20. A method according to claim 17 wherein the virtual security appliance is selected by a load balancer external to the virtual security platform.

21. A method according to claim 17 wherein the virtual security appliance is selected by a switch external to the virtual security platform.

22. A method according to claim 14 wherein at least one of the data communication sources is external to the host data processing machine.

23. A computer program embodied in a computer readable medium, the computer program comprising instructions performing a set of actions comprising:
establishing a virtualization layer on a host data processing machine;
constructing at least one virtual security appliance in the virtualization layer, each of the at least one virtual security appliance being configured for receiving, via a network interface, data communications from at least one data communication source and for initiating a security function responsive to one of said data communications meeting predetermined criteria.

24. A computer program according to claim 23 wherein the security function comprises an action selected from the set consisting of preventing the data communication from reaching the at least one other virtual network device, activating a security application, creating an electronic record of the data communication and transmitting an alert.

25. A computer program according to claim 23 wherein the predetermined criteria includes a set of security rules for use in conjunction with the security function, at least a portion of the security rules being storable in a data storage module in the virtual security appliance.

26. A computer program according to claim 23 wherein the at least one data communication source comprises a virtual network device.

27. A computer program according to claim 23 wherein the at least one data communication source comprises a physical data communication source.

28. A computer program according to claim 23 wherein the virtual security platform is configurable so that all of the data communications from a selected one of the at least one data communication source are received by a particular one of the at least one virtual security appliance.

29. A computer program according to claim 23 wherein the set of actions further comprises:
positioning a virtual load balancer intermediate the network interface and the at least one virtual security appliance, the virtual load balancer being configured for receiving the data communications and, for each data communication, selecting one of the at least one virtual security appliance and directing the data communication to the selected virtual security appliance.

30. A computer program according to claim 29 wherein the virtual load balancer is configured to select the virtual security appliance based on predetermined criteria relating to at least one of the set consisting of communications traffic level and virtual security appliance capacity.

31. A computer program according to claim 23 wherein set of actions further comprises:
positioning a virtual switch intermediate the network interface and the at least one virtual security appliance, the virtual switch being configured for receiving the data communications and, for each data communication, selecting one of the at least one virtual security appliance and directing the data communication to the selected virtual security appliance.

32. A computer program according to claim 31 wherein the virtual switch is configured to select the virtual security appliance based on predetermined criteria relating to at least one of the set consisting of communications type and traffic content.

33. A computer program according to claim 23 wherein one or more of the at least one data communication source is external to the host data processing machine.

34. A computer program according to claim 33 wherein the network interface is configured for receiving external data communications from the one or more of the at least one data communication source external to the host data processing machine via a load balancer external to the virtual security platform and for communicating the external data communications to specific ones of the at least one virtual security appliance as determined by the load balancer.

35. A computer program according to claim 33 wherein the network interface is configured for receiving external data communications from the one or more of the at least one data communication source external to the host data processing machine via a switch external to the virtual security platform and for communicating the external data communications to specific ones of the at least one virtual security appliance as determined by the switch.
